(19) United States
(12) Patent Application Publication
(10) Pub. No.: US 2026/0340306 A1
(43) Pub. Date: Oct. 29, 2026

(54) RAG GENERATION EVALUATION THROUGH MULTIPLE-CHOICE QUESTION AND ANSWERING SCHEME

(71) Applicant: Dell Products L.P., Round Rock, TX (US)

(72) Inventors: Cinthia Cristina Calchi Kleiner, Campinas (BR); David Burth Kurka, Campinas (BR); Roberto Nery Stelling Neto, Rio de Janeiro (BR)

(21) Appl. No.: 19/188,879

(22) Filed: Apr. 24, 2025

(51) Int. Cl. G06F 40/40

(52) U.S. Cl. CPC G06F 40/40

(57) ABSTRACT

One example method is for evaluating the performance of a generator component of a RAG (retrieval augmented generation) system. This method includes receiving a question from a user, defining a triple that includes the question, a context for the question, distractor response options for the question, and correct response options for the question, formulating a prompt as a multiple-choice question with multiple answer choices, providing the prompt to a model, evaluating the answer, from the multiple answer choices, that was selected by the model based on the prompt, and scoring the model by comparing the answer with a reference.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to retrieval augmented generation (RAG) methods and systems. More particularly, at least some embodiments relate to systems, hardware, software, computer-readable media, and methods for RAG generation evaluation through a multiple-choice question and answering scheme

### BACKGROUND

RAG is a technique used to enhance the capabilities of Large Language Models (LLM) by combining retrieval and generation techniques. By adding relevant documents from external knowledge to an LLM instruction, generally via prompting techniques, RAG systems augment the LLM's generator capacity in producing contextualized responses grounded by facts and reducing hallucinations. See [1] below. This approach may be used in various services which usually present a chatbot interface in which users can make business-specific questions and obtain custom answers generated by LLMs using company data as sources.

Evaluating entire RAG systems entails evaluating the capacity of the retrieval in identifying relevant text passages and assessing the competence of the language model in using the augmented information to formulate an expected response. Unlike the retrieval component, which can be evaluated with straightforward metrics like precision and recall, the answer provided by the generator component must be evaluated in different aspects such as correctness, reference overlapping, coherence and fidelity with the retrieved information and the intention of the question.

Natural Language Processing (NLP) metrics such as BLEU, ROUGE, BERT-Score, among others, are based on word overlap matches or semantic similarity, failing to capture the nuances of the response generated by LLMs, making it an unsolved challenge in natural language processing research. See [2].

With the rise of Generative AI, the use of LLMs as evaluators, sometimes referred to as ‘LLM-as-a-judge,’ is being explored as an alternative for with human-evaluation-agreement. See [3]. This method combines multiple prompt engineering strategies with a strong LLM as GPT-3.5 and GPT-4 to score the quality of the generated content. There are different paradigms of using LLM-as-judges, including creating quality scores that can act as binary evaluators, scoring with the generated content meets a predefined criterion, as coherence, or analyzing it with a continuous numerical score. The performance of these methodologies relies on the LLM internal information, which is not provided for closed models such as GPT-4, which leads to a lack of accountability and transparency. Moreover, some of these evaluation methods depend on multiple prompt steps to eventually assign and compute the content quality, transforming the assessment process into an expensive, time-consuming, and brittle task.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an example multiple-choice evaluation method, according to one embodiment.

FIG. 2 discloses an example of a possible multiple-choice prompt, according to one embodiment.

FIG. 3 discloses an example of a formulated prompt used in experiments, according to one embodiment.

FIG. 4 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to retrieval augmented generation (RAG) methods and systems. More particularly, at least some embodiments relate to systems, hardware, software, computer-readable media, and methods for RAG generation evaluation through a multiple-choice question and answering scheme.

RAG processes may be used to enhance and augment the capabilities of LLMs. A RAG process may comprise a component of the LLM itself. Among other things, for example, a RAG process may be used to generate content responsive to a query. Such LLMs, in association with which a RAG process may be employed, may be used in a wide range of applications including, but not limited to, chatbots, virtual assistants, and any entity that may generate and/or retrieve content based on one or more prompts, and in response to a query which may, or may not, be generated by a human. One or more example embodiments may provide a system, method, and schema, for evaluation of RAG content, such as may be generated by an LLM for example, using a multiple-choice question and answering scheme.

One such method according to one embodiment may be implemented in connection with a dataset that comprises known questions and answers and may be used as reference for a RAG content evaluation. This method may comprise operations including, but not limited to, considering a given question, an expected answer from the dataset, and a retrieved context for answering the question: for the given question, generating a question, context, and answer, triple; producing distractor responses options for the question, wherein the options comprise an augmented distractor, and an incorrect distractor; formulating a prompt as a multiple choice question, based on the triple, the augmented distractor, and the incorrect distractor; receiving an output generated by an LLM based on the prompt; evaluating the output; and, scoring the LLM by comparing the output with a reference dataset.

It is noted that a triple, according to an embodiment, comprises the question, a context for the question, distractor response options for the question, and correct response options for the question. Although four elements are recited here, the distractor response options and correct response options, collectively, comprise a single element of the triple.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may reduce a complexity of RAG generator evaluations, relative to approaches that do not employ one or more of the disclosed techniques. An embodiment may address and resolve semantic misalignment limitations known to exist in conventional NLP (natural language processing) metrics. An embodiment may automate the evaluation of the generator component in RAG systems in various domains including, but not limited to, a customer services domain. Various other advantages of one or more example embodiments will be apparent from this disclosure.

### A. References

Reference may be made herein to various documents, listed below. These documents are incorporated herein in their respective entireties by this reference.
[1] Lewis, Patrick, et al. “Retrieval-augmented generation for knowledge-intensive nip tasks.” Advances in Neural Information Processing Systems 33 (2020): 9459-9474.
[2] Lin, Yen-Ting, and Yun-Nung Chen. “Lil-eval: Unified multi-dimensional automatic evaluation for open-domain conversations with large language models.” arXiv preprint arXiv:2305.13711 (2023).
[3] Zeng, Zhiyuan, et al. “Evaluating large language models at evaluating instruction following.” arXiv preprint arXiv:2310.07641 (2023).
[4] Adlakha, Vaibhav, et al. “Evaluating correctness and faithfulness of instruction-following models for question answering.” arXiv preprint arXiv:2307.16877 (2023).
[5] Wang, Cunxiang, et al. “Evaluating open-qa evaluation.” Advances in Neural Information Processing Systems 36 (2024).
[6] https://chat.lmsys.org/?leaderboard
[7] Chiang, Wei-Lin, et al. “Chatbot arena: An open platform for evaluating LLMs by human preference.” arXiv preprint arXiv:2403.04132 (2024).

### B. Aspects of an Example Context for One Embodiment

The following is a discussion of aspects of an example context for various embodiments. This discussion is not intended to limit the scope of the claims or this disclosure, or the applicability of the embodiments, in any way.

With the surge of RAG applications, metrics for evaluating the generation capacity of the RAG have become an important point of research, but with limited options. For example, common NLP metrics such as ROUGE, METEOR, BLEU, BERT-Score [4-5], among others, are based on word overlap matches or semantic similarity, but fail to capture the nuances of the response generated by LLMs. More recent approaches use LLM-evaluators to assess the content generation, but such approaches still have limitations, relying mainly on the internal knowledge of non-open-source models such as GPT-4 [4-5]. As well, these evaluators typically utilize multiple prompts for the assessment procedure, transforming the evaluation process into an expensive and time-consuming task.

Although options exist for evaluating RAG generator components, at least one embodiment differs from such conventional approaches in that such an embodiment evaluates the LLM or other model by transforming it into a multiple-choice decision problem. Thus, an embodiment may comprise, and implement, an evaluation method for RAG systems that uses this mechanism of constraining a business-specific open answer problem into a multiple-choice evaluation task.

In more detail, the rise of LLM systems, capable of producing original and elaborate text outputs at each invocation, brought many new possibilities of applications, but also new challenges due to its unpredictability and evaluation complexity. Since the generator component of a RAG system produces eloquent and rich responses, the task of discerning answers that only superficially look good, from those answers that are actually correct and precise, is still an open challenge.

Human evaluation is the most reliable methodology for generation evaluation, but it is impracticable for large datasets. Therefore, automated techniques based on NLP and LLMs have been proposed as possible approaches. The principal evaluation methodologies and their pros and cons are described below.

### B.1 Lexical Matching

Lexical matching metrics assess the quality of a model generation based on common words, that is, the lexical n-grans overlap, between a reference and the evaluated text. Some of the most used metrics of this category are ROUGE, METEOR and BLEU. Despite being computationally efficient, these metrics tend not to align with human judgement because they lack semantic understanding and fail to handle synonyms and paraphrases [4].

### B.2 Neural Evaluation

Neural evaluation uses embeddings computed from trained models to evaluate the similarity between sentences. One of the most used metrics is BERT-Score, which utilizes the BERT (bidirectional encoder representations from transformers) model to produce embeddings, and the cosine similarity between the embeddings of the evaluated and the reference texts are used to compute precision, recall and f1-score, assessing the quality of the generated text. Although such metrics consider some aspects of context semantic understanding, they still lack contextual understanding since embeddings cannot fully capture the contextual details of a given text. Moreover, they are sensitive to verbosity, penalizing texts that provide detailed explanations. In addition to that, the used embedding model cannot generalize well to context that require specialized data domain knowledge [5].

### B.3 Modern Approaches—LLM-Evaluator

A more recent approach relies on the use of LLMs as evaluators to assess the quality of the generated text. By combining the use of LLMs and prompt engineering techniques the evaluation process can be performed considering different strategies. It is possible to score the generated content considering a predefined criterion such as relevance or coherence and instruct the LLM to output a True/False evaluation or a numerical score.

A significant challenge presented by these methodologies is that the score/evaluation relies on the LLMs internal information, which is not provided by most models that are served behind an API, such as GPT-4, resulting in a lack of explicability and transparency. Another significant drawback is that these techniques are extremely sensitive to prompt engineering, so small variations in the prompt structure can result in large variability in the evaluation. Moreover, the analysis can inherit biases originated from the evaluator model training dataset. This can influence the preferences of the evaluation process for certain types or structures of answers [5].

### C. Overview of Aspects of One or More Embodiments

### C.1 Introduction

Among other things, an embodiment comprises an approach for evaluating the performance of the generator component of Retrieval Augmented Generation (RAG) systems, a still open problem on modern NLP research. Accordingly, the present disclosure comprises various approaches for the definition and use of multiple-choice questions as a method to evaluate LLMs used as part of a RAG based system generator component to reduce the complexity of a RAG evaluation process. One or more disclosed embodiments comprise an effective and more constrained evaluation method that is able to judge the ability of the evaluated model with respect to interpretating the nuances of the provided question and retrieved contexts, including noisy scenarios, by selecting the option with a superior and more complete answer for the question under consideration.

By applying an embodiment in question-answer tasks, such as may be found in chatbot domains and other similar domains, an embodiment may improve customer satisfaction in services powered by LLMs and RAG systems. With the disclosed evaluation method for LLMs, an embodiment is capable of selecting the most suitable model for each the respective nuances of a given application. This may result in more accurate and truthful responses, which directly affects customer satisfaction. This evaluation approach can also be extended to any RAG application of a company that relies on private data.

Thus, one or more embodiments may address and resolve various challenges presently known to exist. Such challenges may include, but are not limited to: reducing the complexity of RAG generator evaluations; addressing the semantic misalignment limitations in existing traditional NLP metrics; and, automating the evaluation of a generator component in RAG systems in domain such as the customer services domain.

### C.2 Discussion

One or more embodiments comprise a method for the evaluation of the generation component of a RAG based LLM solution by converting the open answer problem into a multiple-choice scenario. The generation component of RAG systems is typically composed of an LLM that generates answers to user prompted questions utilizing content retrieved from external databases and can generate original answers for any question asked. Embodiments disclosed herein operate to objectively evaluate the semantical understanding performance of a model, so as to determine the best model, from among a set of candidate models, to perform the content generation task.

Specifically, an embodiment may assume the existence of a dataset D of known questions and answers that will be used as reference for the evaluation. This dataset can be generated in semi-automatic ways, or completely by humans. As well, there is a RAG retrieval component of an embodiment which, given a question such as may be generated by a human user or other entity, is operable to provide a relevant context to produce a meaningful answer.

Considering a given question (q), an expected answer (a) from the dataset D, a retrieved context (r) useful for answering q, the following steps of an embodiment, a Figure depicting which is discussed elsewhere herein, may be defined:
Distractorsformulation: For each question, context and answer triple (q,r,a), produce the following distractor response options for each question:
   Augmented distractors: Augment the correct answer a, creating n_{AD} noisy answers options (AD). These options will be related to the background of the question, but may not be completely accurate; and
   Incorrect distractors: Create n_{ID} synthetic incorrect answers (ID) unrelated to the background of the question.
Multiple-choice prompting: Formulate a prompt, usable by an LLM or other model, as a multiple-choice question, based on q, r, a, and the sets ID and AD as input. The prompt will require that the evaluated model selects the most suitable option for the given question (a) and retrieved contexts. The order where a appears in the multiple choice should be random, to prevent location biased selection from models—for example, a low performance model could, conceivably, select always the first option, or the last option but would have a high score if the first option or last option is correct throughout the evaluation process.
Answer Evaluation: Since the LLM being evaluated was prompted with a multiple-choice question, the model output can be evaluated by comparing its probabilities of generating the tokens for each of the choices given in the question and ranking these values as choices preferences.
Scoring: Score the model by comparing the answers selected by the LLM (c) with the references. In principle, any sensible scoring system can be applied, one possible embodiment is proposed below.
   The score can be measured by regular accuracy metrics, evaluating for multiple runs of different questions in the dataset.
   Alternatively, the performance can also be calculated with a weighted score, applying penalties for selected answers. Since some answers in ID can be totally nonrelated with the correct answer scope, if the model chooses one of them, a heavier penalty can be applied to the score (See section 6 for more details).

Thus, an embodiment is based on a hypothesis that the capacity of a model to select the best alternative for a given question is correlated with the ability of that model to generate open-answers in the same business-case/domain and context. Underlying both tasks, the model needs to “reason” on the nuances of a given question, the retrieved contexts and it must distinguish noisy context non relevant. Therefore, by evaluating a model in the multiple-choice task, an embodiment may also be implicitly evaluating the model with respect to the answer generation task, making this method useful for assessing and comparing models.

As disclosed herein, one or more embodiments may comprise various useful features and aspects, although it is not required that any embodiment comprise any of such features or aspects. The following examples are illustrative, but not exhaustive.

An embodiment may comprise an evaluation method capable of judging the performance of a generator model component of RAG systems by reducing the complexity of an open answer problem to a multiple choices scenario. An embodiment may assess the aptitude of a model in understanding the refinement of the question and retrieved contexts, even in noisy scenarios, by evaluating the capacity of that model to elect among a pool of candidate answers, the alternative superior and more relevant information for the presented question.

### D. Detailed Discussion of Aspects of One or More Embodiments

### D.1 Introduction

One embodiment comprises a method that includes generating, from a dataset of questions and expected answers, prompts that contain multiple-choice questions. These multiple-choice questions are used to evaluate candidate LLM models on their ability to understand the task contained in the question and its aptitude to reason on the domain specified by the questions and its contexts.

It is expected that the ability of an LLM model to answer multi-choice questions is positively correlated to the ability of that model to answer direct questions or generating coherent answers and text. By evaluating how a LLM performs in the multi-choice problem, an embodiment may have a proxy to the model competence in generating open answers to general questions. An analogy would be exam strategies to evaluate human knowledge—for example, it is known that there is a positive correlation between the results to answering multiple-choice questions and answering open questions. The disclosed experimental results, discussed below, corroborate this hypothesis. Finally, an embodiment may define, and use, a scoring function to evaluate the performance of a model on a set of questions transformed into multiple-choice prompts, thus creating a consistent score for a model, that can be used to compare the generation performance of the model on a specific RAG use case against other candidates evaluated in the same manner.

### D.2 Aspects of One Example Embodiment of a Method

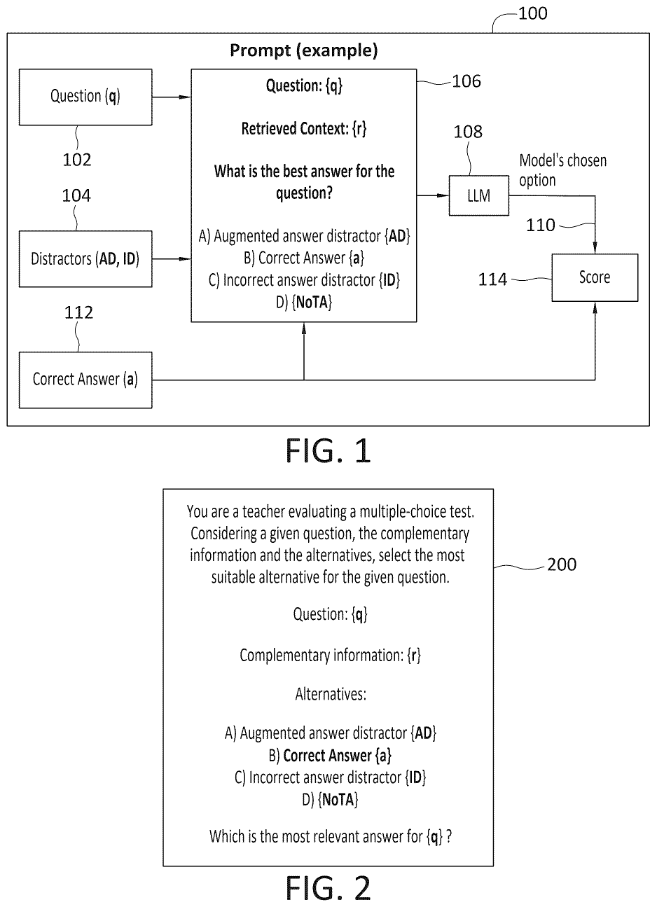

FIG. 1 discloses an evaluation method 100 according to one embodiment. As shown, the method 100 comprises a multiple-choice evaluation method.

### D.2.1 Preamble

Assume a dataset (D), generated completely by humans or through semiautomatic ways, containing triplets (q, r, a) where:
q is a domain specific question, simulating a user interaction with the RAG system.
r is a retrieved context with enough information to answer q.
a is the expected answer for q given r.

### D.2.2 Distractors Formulation

In a multiple-choice scenario, it may be expected that in addition to the correct alternative, there will be options, or distractors, capable of evaluating the discernment of the entity that it is being tested. To construct answers alternatives qualified for it, it is necessary, in one embodiment, to construct augmented and incorrect answers variants. The number of distractors can vary in different applications/scenarios.
Augmented Distractors (AD): Variants related with the question/context content that are created by data augmentation techniques applied on the correct answer. AD can be formulated through different strategies, for example:
   Replacing named entities: Named entities are specific words that represent information related to the real word, as locations, dates, product names, and people's names, for example. One possible approach for generating augmented text is to replace the named entities of the correct alternative with different entities, for example, replacing a computer model with another model.
   Answer fusion: addition of parts of another random answer into the correct answer structure.
   Sentence deterioration: Exclusion of sentence segments of the correct answer.
Incorrect Distractors (ID): Variants non-related to question/context content. Can be formulated in different approaches as:
   Random shuffle: Shuffle all other Q&A pairs and selects a random incorrect and unrelated answer as a wrong alternative

As well, an embodiment may evaluate the model understanding capacity when there is no suitable answer among the alternatives. Accordingly, the option “None of the alternatives” (NoTA) can be used both as the correct answer, and/or as a distractor.

With particular attention now to the example of FIG. 1, the example method 100 may begin with the definition and generation of various inputs 102, such as one or more questions, and 104 such as various distractors. As noted earlier, the questions and distractors may be used in the formation of a triple, or other form, that can be provided as an input to a prompt 106. As shown, the prompt 106 may comprise a question that is to be answered, as well as a context for the question. Respective answers to the question may be generated using an augmented answer distractor (AD) and an incorrect answer distractor (ID). In the illustrative example of FIG. 1, the AD may indicate a particular correct answer ‘(a),’ which was input to the prompt 106, while the ID may indicate simply that the answer is not ‘(a).’

The prompt 106 may be fed to a model 108, such as an LLM for example, and the model 108 may use the prompt 106 to generate an output 110. In the example of FIG. 1, the output 110 may comprise what the model 108 deems to be the best answer—provided by one of the AD or the ID—to the question, which was input to the prompt 106 as 102.

The output 110 may be compared with the correct answer ‘(a)’ 112, that was provided to the prompt 106. The comparison may be used to generate a score 114 for the model 108 as to the answer that the model 108 generated to the question 102. That is, a relative, or absolute, quality or accuracy of the answer may be reflected in the score 114.

### D.2.3 Multiple-Choice Prompting

An important point in an automated evaluation process based on LLM as judges is the design of an effective prompt. In the multiple-choice evaluation of a RAG system, the prompt, according to one embodiment, should contain:
An instruction informing the model about the components present on the prompt. The components are:
   Question (q)
   Retrieved contexts (c)
   Alternatives {a, ID, AD, NoTA}
An instruction requiring the selection of the most suitable alternative for specified question and the retrieved contexts.

In one embodiment, the location of the correct answer among the alternatives must be random to avoid positioning preferences. An example of a multi-choice prompt 200, according to one embodiment, is disclosed in FIG. 2, where n_{AD}=1 and n_{ID}=1. The example prompt 200 contains a brief explanation of the task the LLM must perform. It also contains the indication of the question, retrieved contexts, which are indicated as complementary information, and the alternatives.

### D.2.4 Scoring

Once a LLM, or simply ‘model,’ receives a multiple-choice prompt, such as the prompt 200 for example, it will generate an output. That is, the LLM will perform a generation process to create an output, that is, an LLM-generated output. This LLM-generated output, or simply, ‘output,’ may be used to evaluate the ability of the model to answer the given question. For this, an embodiment may first extract the LLM choice (c) and use it to score the LLM on a specific answer. In an embodiment, there may be two alternatives for extracting the LLM choice (c), from the LLM output, namely:
First word: by simply inspecting the LLM output, consider c as the first alpha-numeric word (i.e., exclude spaces and newlines) in the output c can be a valid alternative, such as “a”, “b”, “c”, “d” for example, or another undefined word. This option may be used when the output probabilities of a model are not accessible.
Most likely token within alternatives: if the output probabilities of a model, that is, the probability distribution or logits for all tokens in a LLM vocabulary, are available for inspection, it is possible to directly compare the probabilities of the LLM outputting the tokens corresponding to each of the valid alternatives, such as “a”, “b”, “c”, “d” for example, and defining c as the token, as among the valid alternatives, with the highest probability. Thus, the c will be constrained to always be equal to one valid alternative. This option may be preferred when the output probabilities of a model are accessible.

With c defined, an embodiment may compute

$${s}_{q}^{M} ,$$

the score of model M for question q as:

$${s}_{q}^{M} = \{ \begin{matrix}1 , & c = {a}_{idx} \\ {S}_{AD} , & c ∈ {A}_{AD} \\ {S}_{ID} , & c ∈ {A}_{ID} \\ 0 , & otherwise\end{matrix}$$

where a_{idx} is the alternative containing the right answer a, A_{AD} the set of alternatives containing augmented distractors, A_{ID} the set of alternatives containing incorrect distractors, S_{AD} the score when choice c refers to a augmented distractor, and S_{AD} the score when choice c refers to a augmented distractor.

In its simplest form, an embodiment may define S_{AD}=0 and S_{ID}=0, so that points are given only when the model chooses the correct choice. Alternatively, partial or negative scores can be given to S_{AD} and S_{ID} to weight erroneous behavior.

Finally, a model may be evaluated over a complete dataset D generating the score S^{M}, as the arithmetic mean over all questions in the dataset:

$${S}^{M} = {\sum }_{q ∈ D} \frac{{s}_{q}}{\vert D \vert}$$

Here, the model score, S^{M} may be directly used to compare and rank a model M against other models regarding its answer generation abilities.

### E. Aspects of Some Example Experiments and Results

As a practical example, the inventors created a dataset with 90 questions that were submitted to the multiple-choice evaluation process. The data comprises the elements presented in section D.2 above:
Question (q),
Retrieved contexts (r),
Alternatives (a, b, c and d) which were randomly filled by each of the following options:
   expected answer (a)
   one augmented distractor (AD)
   one incorrect distractor (ID)
   “None of the alternatives” (NoTA)
      In some cases, NoTA is the correct answer,
Ground truth (a_{idx}), indicating which alternative (a, b, c or d) is the correct for the given question

The following dictionary is an example of a dataset entry.

{
“Question”: “What is the primary focus of the PowerScale family in terms of workloads?”,
“Context”: “Title: h19098-positioning-dell-tech-storage-portfolio.pptx\nDescription: Scale out file
storage Modern, flexible scale out file storage available through APEX Scale out object storage
Native S3 support for modern applications in hybrid cloud in addition to traditional LTR Storage
positioning Unstructured data storage ECS PowerScale ECS/ObjectScale Emerging workloads:
Machine Learning, Al, Analytics, IoT, Cyber, Data Virtualization Industry workloads: Healthcare,
Lifesciences, EDA, Mfg, M&E, Assisted Driving, High Freq. Trading, Energy/Oil IT workloads:
Archive, Backup, Video, File Shares, Directories, File Consolidation FILE OBJECT On Premises
Private CloudCloud ColocationPublic Cloud 26 As mentioned earlier, the PowerScale family is our
lead solution for file workloads, while ECS is our lead solution for object workloads. The
PowerScale family is a fit for markets where the primary workloads are file shares, home
directories, archive and big data analytics across all industries and verticals ( . . . ).”
“Expected_answer”: “The primary focus of the PowerScale family is on file workloads, while the
ECS family is the lead solution for object workloads. PowerScale is suitable for markets where the
primary workloads are file shares, home directories, archive and big data analytics across all
industries and verticals”
“AD”: “The primary focus of the PowerScale family is on object workloads, while the ECS family is
the lead solution for file workloads. PowerScale is suitable for markets where the primary
workloads are file shares, home directories, archive and big data analytics across all industries
and verticals”,
“ID”: ““The purpose of Centera modernization is to simplify migration and automatic integration”
“Abstain_alternative”: “None of the alternatives”,
“Groundtruth”: “d”,
“Alternative_a”: Abstain_alternative,
“Alternative_b”: AD,
“Alternative_c”: ID,
“Alternative_d”: Correct_answer
}

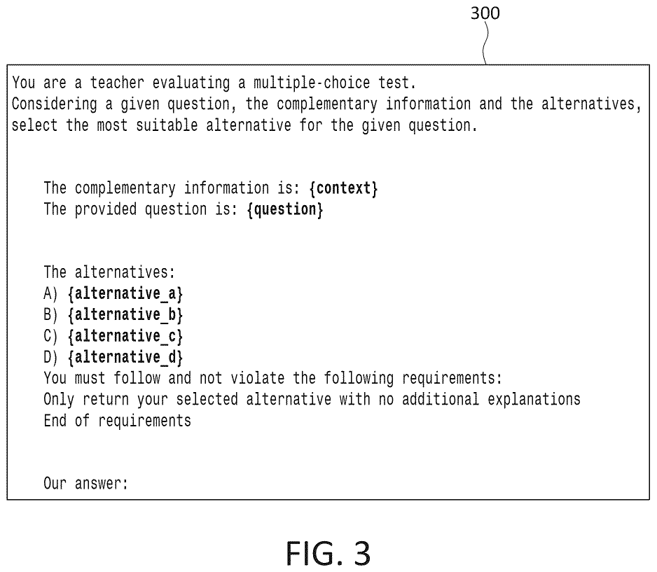

Each example of dataset was submitted to the example formulated prompt 300 disclosed in FIG. 3. The example prompt 300 requires that the evaluated model selects the most suitable alternative for a given question considering the complementary information, that is, the retrieved contexts in this example.

With the dataset and the designed prompt, the performance of three different LLM models was assessed: Mixtral, Mistral and Gemma. The configuration of each model is presented in Table 1, below.

TABLE 1
Evaluated models configuration.

| Model | Parameters (bi) | Version |
|---|---|---|
| Gemma | 7 | 7b-instruct |
| Mistral | 7 | 7b-instruct-v0.2 |
| Mixtral | (8 × 7) | 8 × 7b-instruct-v0.1 |

For the three assessed models indicated in Table 1, the presented prompt 300 was filled with each example of the dataset. After iterating the process over all 90 instances, the performance of the models was evaluated through the scoring function, defined earlier herein, considering S_{AD}=0 and S_{ID}=0. The final score (S^{M}) for each model is provided in Table 2, below.

TABLE 2
Multiple-choice evaluation results

| Model | Score (S^{M}) (%) |
|---|---|
| Mixtral | 96.66 |
| Mistral | 82.66 |
| Gemma | 76.66 |

It is noted that, as shown in the example of Table 2, the Mixtral model had the best result (96.66%), followed by Mistral (82.66%) and Gemma (76.66%).

These results seem to reproduce the results of human evaluation, such as the presented at the LMSYS benchmark. In that benchmark, volunteer users interacting with a web interface, hosted in HuggingFace, select the most suitable answer, as between two options, for a given question/prompt over more than one million “blind” human votes. See [6] and [7].

The evaluated positions of the models on LMSYS benchmark are represented in Table 3, below. Comparing the results with the LMSYS chatbot arena, it is noted that the score obtained by the inventors agrees with the human evaluation presented in the benchmark, demonstrating the preferences for Mixtral, Mistral and Gemma, respectively. These results corroborate a hypothesis, of the inventors, that the capacity of a model in selecting the best alternative for a given question is correlated with the ability of that model to generate open answers.

TABLE 3
LMSYS model positioning

| Model | Version | Rank |
|---|---|---|
| Mixtral | 8 × 7b-instruct-v0.1 | 48 |
| Mistral | 7b-instruct-v0.2 | 67 |
| Gemma | 7b-instruct | 83 |

### F. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. Further Example Embodiments

Following are some further example embodiments. These are presented only by way of example and are not intended to limit the scope of this disclosure or the claims in any way.

Embodiment 1. A method for evaluating the performance of a generator component of a RAG (retrieval augmented generation) system, comprising: receiving a question from a user; defining a triple that comprises the question, a context for the question, distractor response options for the question, and correct response options for the question; based on the triple, formulating a prompt as a multiple-choice question with multiple answer choices; providing the prompt to a model; evaluating the answer, from the multiple answer choices, that was selected by the model based on the prompt; and scoring the model by comparing the answer with a reference.

Embodiment 2. The method as recited in claim 1, wherein the model comprises an LLM (large language model).

Embodiment 3. The method as recited in claim 1, wherein the distractor response options comprise an augmented distractor, and an incorrect distractor.

Embodiment 4. The method as recited in claim 1, wherein one of the distractor responses options creates noisy answer options, and another of the distractor response options creates a synthetic incorrect answer not related to the context.

Embodiment 5. The method as recited in claim 1, wherein the question comprises an open answer problem, and the prompt reduces the open answer problem to a multiple-choice scenario.

Embodiment 6. The method as recited in claim 1, wherein the prompt is generated from a dataset of questions, and expected answers to those questions.

Embodiment 7. The method as recited in claim 1, wherein the answer output by the model is chosen by the model as the best answer, as among a defined group of answers, to the question.

Embodiment 8. The method as recited in claim 1, wherein the prompt comprises an instruction informing the model about the question, the context for the question, and the distractor response options.

Embodiment 9. The method as recited in claim 1, wherein a location, in the prompt, of a correct answer to the question is randomly determined.

Embodiment 10. The method as recited in claim 1, wherein the answer is extracted from an output generated by the model based on the prompt.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

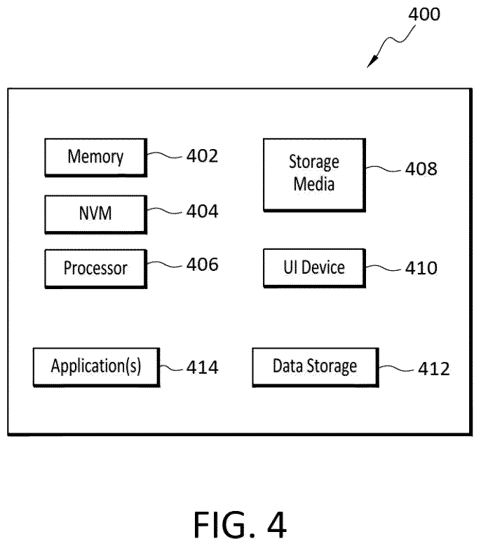

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for evaluating a performance of a generator component of a RAG (retrieval augmented generation) system, comprising:
receiving a question from a user;
defining a triple that comprises the question, a context for the question, distractor response options for the question, and correct response options for the question;
based on the triple, formulating a prompt as a multiple-choice question with multiple answer choices;
providing the prompt to a model;
evaluating the answer, from the multiple answer choices, that was selected by the model based on the prompt; and
scoring the model by comparing the answer with a reference.

2. The method as recited in claim 1, wherein the model comprises an LLM (large language model).

3. The method as recited in claim 1, wherein the distractor response options comprise an augmented distractor, and an incorrect distractor.

4. The method as recited in claim 1, wherein one of the distractor response options creates noisy answer options, and another of the distractor response options creates a synthetic incorrect answer not related to the context.

5. The method as recited in claim 1, wherein the question comprises an open answer problem, and the prompt reduces the open answer problem to a multiple-choice scenario.

6. The method as recited in claim 1, wherein the prompt is generated from a dataset of questions, and expected answers to those questions.

7. The method as recited in claim 1, wherein the answer output by the model is chosen by the model as the best answer, as among a defined group of answers, to the question.

8. The method as recited in claim 1, wherein the prompt comprises an instruction informing the model about the question, the context for the question, and the distractor response options.

9. The method as recited in claim 1, wherein a location, in the prompt, of a correct answer to the question is randomly determined.

10. The method as recited in claim 1, wherein the answer is extracted from an output generated by the model based on the prompt.

11. A non-transitory storage medium having stored therein instructions that are executable by one or more hardware processors to perform operations for evaluating a performance of a generator component of a RAG (retrieval augmented generation) system, the operations comprising:
receiving a question from a user;
defining a triple that comprises the question, a context for the question, distractor response options for the question, and correct response options for the question;
based on the triple, formulating a prompt as a multiple-choice question with multiple answer choices;
providing the prompt to a model;
evaluating the answer, from the multiple answer choices, that was selected by the model based on the prompt; and
scoring the model by comparing the answer with a reference.

12. The non-transitory storage medium as recited in claim 11, wherein the model comprises an LLM (large language model).

13. The non-transitory storage medium as recited in claim 11, wherein the distractor response options comprise an augmented distractor, and an incorrect distractor.

14. The non-transitory storage medium as recited in claim 11, wherein one of the distractor response options creates noisy answer options, and another of the distractor responses options creates a synthetic incorrect answer not related to the context.

15. The non-transitory storage medium as recited in claim 11, wherein the question comprises an open answer problem, and the prompt reduces the open answer problem to a multiple-choice scenario.

16. The non-transitory storage medium as recited in claim 11, wherein the prompt is generated from a dataset of questions, and expected answers to those questions.

17. The non-transitory storage medium as recited in claim 11, wherein the answer output by the model is chosen by the model as the best answer, as among a defined group of answers, to the question.

18. The non-transitory storage medium as recited in claim 11, wherein the prompt comprises an instruction informing the model about the question, the context for the question, and the distractor response options.

19. The non-transitory storage medium as recited in claim 11, wherein a location, in the prompt, of a correct answer to the question is randomly determined.

20. The non-transitory storage medium as recited in claim 11, wherein the answer is extracted from an output generated by the model based on the prompt.
